(19) United States
(12) Patent Application Publication
(10) Pub. No.: US 2015/0131813 A1
(43) Pub. Date: May 14, 2015

(54) CAPACITOR-TYPE SENSOR READ-OUT CIRCUIT

(71) Applicant: Electronics and Telecommunications Research Institute, Daejeon (KR)

(72) Inventors: Yi-Gyeong KIM, Daejeon (KR); Min-Hyung Cho, Daejeon (KR); Young-deuk JEON, Daejeon (KR); Tae Moon ROH, Daejeon (KR); Woo Seok YANG, Daejeon (KR); Jong-Kee KWON, Daejeon (KR)

(21) Appl. No.: 14/304,156

(22) Filed: Jun. 13, 2014

(30) Foreign Application Priority Data
Nov. 11, 2013 (KR) 10-2013-0136382

(51) Int. Cl. H04R 3/00; H04R 1/08

(52) U.S. Cl. CPC H04R 3/00; H04R 1/08
USPC 381/119

(57) ABSTRACT

Provided is a capacitor-type sensor read-out circuit. The capacitor-type sensor read-out circuit includes: a signal conversion unit outputting a sensor signal inputted from a sensor; a voltage booster generating a bias voltage; and a capacitor-type signal coupling circuit receiving the sensor signal as a feedback, mixing the received sensor signal with the bias voltage, and outputting the mixed signal.

### CROSS-REFERENCE TO RELATED APPLICATIONS

This U.S. non-provisional patent application claims priority under 35 U.S.C. §119 of Korean Patent Application No. 10-2013-0136382, filed on Nov. 11, 2013, the entire contents of which are hereby incorporated by reference.

### BACKGROUND OF THE INVENTION

The present invention disclosed herein relates to an electronic device, and more particularly, to a capacitor-type sensor read-out circuit capable of improving a signal to noise ratio (SNR) of a signal from a connected sensor and outputting the improved signal.

A read-out circuit may be connected to various sensors, and process and output a signal outputted from a connected sensor. A microphone sensor among various sensors is configured with an electrode layer and has the same characteristics as a variable capacitor. In such a microphone sensor, a capacitance value changes as an interval between capacitor devices changes according to sound pressure.

At this point, a read-out circuit connected to a microphone sensor applies sensor bias voltage Vmic to the microphone sensor. At this point, in the microphone sensor, when a capacitance value changes according to sound pressure, a voltage of a signal inputted to the read-out circuit changes by Equation 1.

Q=C·V [Equation 1]

where Q is an electrical charge stored in a microphone sensor and C is a capacitance. V is a voltage across the both ends of the microphone sensor.

Through this, the read-output circuit connected to the microphone sensor amplifies and outputs an input signal.

Through an operation for amplifying a signal inputted from the microphone sensor, the read-out circuit amplifies a noise also. As a result, an SNR becomes lower.

### SUMMARY OF THE INVENTION

The present invention provides a capacitor-type sensor read-out circuit improving a signal to noise ratio.

The present invention also provides a capacitor-type sensor read-out circuit improving signal amplification performance.

The present invention also provides a capacitor-type sensor read-out circuit configured to have a small size and driven with lower power consumption.

Embodiments of the present invention provide capacitor-type sensor read-out circuits including: a signal conversion unit outputting a sensor signal inputted from a sensor; a voltage booster generating a bias voltage; and a capacitor-type signal coupling circuit receiving the sensor signal as a feedback, mixing the received sensor signal with the bias voltage, and outputting the mixed signal.

In some embodiments, the sensor signal mixed with the bias voltage may be an alternating current (AC) signal.

In other embodiments, the signal conversion unit may include: a high impedance circuit converting the sensor signal into a voltage signal; a first amplifier outputting the sensor signal converted into the voltage signal; and a second amplifier outputting the sensor signal outputted from the first amplifier.

In still other embodiments, the capacitor-type signal coupling circuit may include a first capacitor feeding back the sensor signal outputted from the first amplifier and mixing the sensor signal with the bias voltage.

In even other embodiments, the capacitor-type signal coupling circuit may include a second capacitor adjusting and outputting a gain of the bias voltage mixed with the sensor signal.

In yet other embodiments, the signal conversion unit may include: a high impedance circuit converting the sensor signal into a voltage signal; a source follower outputting the sensor signal converted into the voltage signal; and an operation amplifier outputting the sensor signal outputted from the source follower.

In further embodiments, the capacitor-type signal coupling circuit may include a first capacitor feeding back the sensor signal outputted from the source follower and mixing the sensor signal with the bias voltage.

In still further embodiments, the capacitor-type signal coupling circuit may include a second capacitor adjusting and outputting a gain of the bias voltage mixed with the sensor signal.

In even further embodiments, the signal conversion unit may include: a high impedance circuit converting the sensor signal into a voltage signal; a common source amplifier outputting the sensor signal converted into the voltage signal; and an operation amplifier outputting the sensor signal outputted from the common source amplifier.

In yet further embodiments, the capacitor-type signal coupling circuit may include a first capacitor feeding back the sensor signal outputted from the common source amplifier and mixing the sensor signal with the bias voltage.

In yet further embodiments, the capacitor-type signal coupling circuit may further include a second capacitor adjusting and outputting a gain of the bias voltage mixed with the sensor signal.

In yet further embodiments, the voltage booster may include: a voltage source generating a boosting voltage; and a resistor generating the bias voltage by filtering the boosting voltage.

In yet further embodiments, the resistor may include at least one of diodes, metal-oxide-semiconductor field-effect transistors (MOSFETs), MOSFETs having a back-to-back structure, diodes having a back-to-back structure, diode-connected P-type metal-oxide-semiconductor (PMOS) transistors having a back-to-back structure, diode-connected N-type metal-oxide-semiconductor (NMOS) transistors having a back-to-back structure, and equivalent resistor implemented as switched-capacitor circuit.

In other embodiments of the present invention, capacitor-type sensor read-out circuits include: a high impedance circuit converting a sensor signal inputted from a sensor into a voltage signal; a first amplifier outputting the sensor signal converted into the voltage signal; a second amplifier outputting the sensor signal outputted from the first amplifier; a voltage booster generating a bias voltage; and a capacitor-type signal coupling circuit receiving the sensor signal outputted from the first amplifier as a feedback, mixing the sensor signal with the bias voltage, and outputting the mixed signal, wherein the capacitor-type signal coupling circuit may include: a first capacitor feeding back the sensor signal outputted from the first amplifier and mixing the sensor signal with the bias voltage; and a second capacitor adjusting and outputting a gain of the bias voltage mixed with the sensor signal.

In some embodiments, the sensor signal mixed with the bias voltage may be an AC signal.

In other embodiments, the first amplifier may include a source follower, wherein the source follower may include: a current source having one end receiving a power voltage; and a transistor having a gate connected to the high impedance circuit, a drain connected to a ground terminal, and a source connected to the other end of the current source.

In still other embodiments, the first amplifier may include a common source amplifier, wherein the common source amplifier may include: a resistor having one end receiving a power voltage; and a transistor having a gate connected to the high impedance circuit, a drain connected to a ground terminal, and a source connected to the other end of the resistor.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a capacitor-type sensor read-out circuit according to an embodiment of the present invention;

FIG. 2 is a view illustrating a capacitor-type sensor read-out circuit according to another embodiment of the present invention;

FIG. 3 is a view illustrating a capacitor-type sensor read-out circuit according to another embodiment of the present invention; and

FIG. 4 is a view illustrating a resistance device in a voltage booster of a capacitor-type sensor read-out circuit according to various embodiments of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

The present invention provides a capacitor-type sensor read-out circuit processing and outputting a signal of a sensor. Among various sensors, a capacitor-type sensor read-out circuit processing a signal of a micro sensor (for example, micro electro mechanical systems (MEMS)) is exemplarily descried. However, the capacitor-type sensor read-out circuit is just for convenience of description and thus also may process signals of various different sensors in addition to a signal of the microphone sensor.

Hereinafter, it will be described about an exemplary embodiment of the present invention in conjunction with the accompanying drawings.

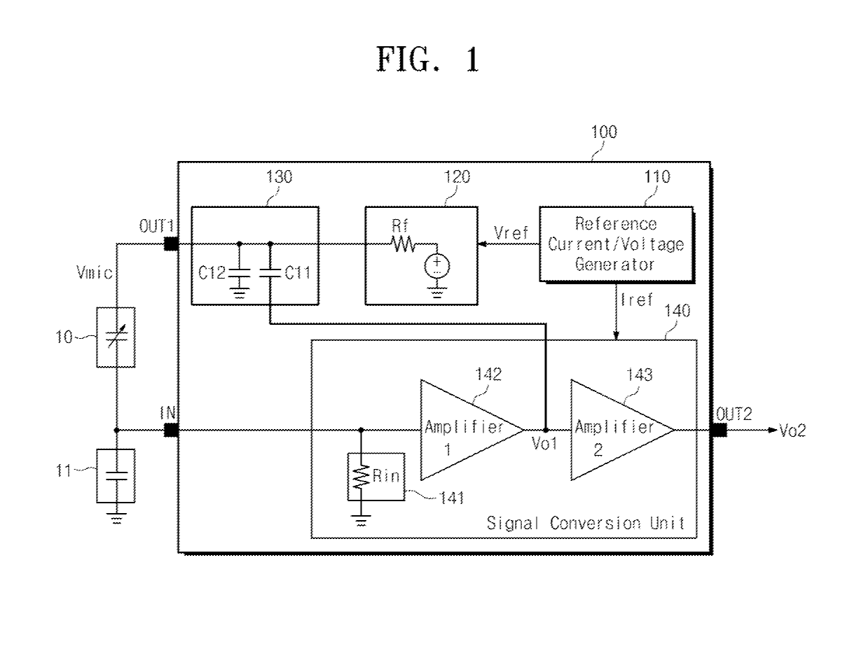

FIG. 1 is a view illustrating a capacitor-type sensor read-out circuit according to an embodiment of the present invention.

Referring to FIG. 1, the capacitor-type sensor read-out circuit 100 includes a reference current/voltage generator 110, a voltage booster 120, a capacitor-type signal coupling circuit 130, and a signal conversion unit 140. The read-out circuit 100 includes a first output terminal OUT 1 outputting a bias voltage Vmic to a sensor 10, an input terminal IN receiving a signal from the sensor 10, and a second output terminal OUT2 outputting a signal detected by the sensor 10. Here, the first output terminal OUT1 and the input terminal IN are connected to the sensor 10 and for example, the sensor 10 may be a microphone sensor. Additionally, one end of a sensor 10 is connected to a contact point between the sensor 10 and the input terminal IN and the other end is connected to a ground terminal.

The reference current/voltage generator 110 generates a reference voltage Vref and a reference current Iref. The reference current/voltage generator 110 outputs the generated reference voltage Vref to the voltage booster 120 and outputs the generated reference current Iref to the signal conversion unit 140.

The voltage booster 120 generates a bias voltage through boosting of a voltage inside on the basis of the reference voltage Vref and outputs the generated bias voltage to the capacitor-type signal coupling circuit 130. The voltage booster 120 includes a resistor Rf. The resistor Rf may have a high impedance and may be positioned at the output. If signal loss does not occur according to a structure of the voltage booster 120, the resistor Rf may not be used.

The capacitor-type signal coupling circuit 130 receives a sensor signal as a feedback inputted through the sensor 10 from the signal conversion unit 140. Here, the sensor signal is an AC signal. That is, the capacitor-type signal coupling circuit 130 mixes a boosting voltage Vcp with an AC signal and then outputs it to the sensor through the first output terminal OUT1. A detailed structure and operations of the capacitor-type signal coupling circuit 130 are described in detail below.

The signal conversion unit 140 processes and outputs a sensor signal (i.e., a current signal) from the sensor 10. Additionally, the signal conversion unit 140 outputs a sensor signal (i.e., a voltage signal), which is mixed with a bias voltage outputted to the sensor 10, to the capacitor-type signal coupling circuit 130. The signal conversion unit 140 includes a high impedance circuit 141, a first amplifier 142, and a second amplifier 143.

The high impedance circuit 141 has an impedance value Rin. One end of the high impedance circuit 141 is connected to an input terminal IN and the other end is connected to a ground terminal Through this, the high impedance circuit 141 converts a current signal inputted through the sensor 10 into a voltage signal. The high impedance circuit 141 outputs the converted voltage signal, i.e., a sensor signal, to the first amplifier 142.

The first amplifier 142 is connected to the high impedance circuit 141 and outputs a voltage signal outputted from the high impedance circuit 141. The first amplifier 142 outputs a sensor signal Vo1 to the second amplifier 143. At this point, the first amplifier 142 outputs the sensor signal Vo1 to a first capacitor C1.

The second amplifier 143 is connected to the first amplifier 142 and outputs a sensor signal Vo1 from the first amplifier 142. The second amplifier 143 outputs a sensor signal Vo2 through the output terminal OUT2.

Here, each of the amplifiers 142 and 143 controls and outputs an inputted sensor signal according to each gain set therein.

Especially, the capacitor-type signal coupling circuit 130 mixes the sensor signal Vo1 outputted from the first amplifier 142 with a bias voltage outputted through the voltage booster 120 and outputs it to the sensor 10.

The capacitor-type signal coupling circuit 130 includes a first capacitor C11 and a second capacitor C12.

The first capacitor C11 connects an output of the first amplifier 142 with an output of the voltage booster 120. The first capacitor C11 mixes the sensor signal Vo1 from the first amplifier 142 with a bias voltage outputted from the voltage booster 120. Here, the sensor signal Vo1 mixed with the bias voltage is an AC signal.

The second capacitor C12 is connected between a contact point of the voltage booster 120 and the first capacitor C11 and a ground terminal. The second capacitor C12 adjusts a gain of output of the first amplifier. The second capacitor C12 outputs a signal of the gain adjusted bias voltage Vmic to the output terminal OUT1.

In such a manner, since the capacitor-type sensor read-out circuit 100 has a structure in which a sensor signal is fed back through the capacitor-type sensor coupling circuit 130, a noise ratio of the second amplifier 143 is reduced. Due to this, the signal to noise ratio (SNR) of the sensor signal Vo2 outputted from the capacitor-type sensor read-out circuit 100 may be improved.

Looking at it in more detail, if the capacitor-type sensor read-out circuit 100 does not include the capacitor-type sensor coupling circuit 130, an output signal Vout_signal1 and a noise Vout_noise1 may be expressed as the following Equation 2.

Voutsignal1=A2·A1·Ap·Vs

Voutnoise1=A2·A1·Vn1+A2·Vn2 [Equation 2]

where A1 is a gain of the first amplifier 142 and A2 is a gain of the second amplifier 143. Vn1 is noise of the first amplifier 142 and Vn2 is noise of the second amplifier 143. Ap is a attenuation factor by the sensor 10 and is expressed the following Equation 3.

$$Ap = \frac{Co}{Co + Cp} \qquad [ Equation 3 ]$$

where Co is a capacitance of the sensor 10 and Cp is a capacitance of a parasitic capacitor 11. For reference, the noise component of the high impedance circuit 141 is excluded from the analysis.

On the contrary, if the capacitor-type sensor read-out circuit 100 includes the capacitor-type sensor coupling circuit 130, an output signal Vout_signal2 and a noise Vout_noise2 may be expressed as the following Equation 4.

$$Vout\_signal 2 = \frac{A 1 \cdot A 2 \cdot {A}_{p}}{1 - A 1 \cdot {A}_{p} \cdot {A}_{c}} \cdot {V}_{s} \\ Vout\_noise 2 = \begin{matrix}\frac{A 1 \cdot A 2 \cdot ( Co + Cp )}{1 - A 1 \cdot {A}_{p} \cdot {A}_{c}} \cdot \\ Vn 1 + A 2 \cdot Vn 2\end{matrix} \qquad [ Equation 4 ]$$

where Ac is a gain component by the capacitor-type sensor coupling circuit 130 and is expressed as the following Equation 5.

$$Ac = \frac{{C}_{C 1}}{{C}_{C 1} + {C}_{C 2}} \qquad [ Equation 5 ]$$

where C_{c1} is a capacitance of the first capacitor C11 and C_{c2} is a capacitance of the second capacitor C12. Descriptions of remaining factors in the Equation 4 refer to those of Equation 2 and Equation 3.

Through this, changes in signal and noise characteristics according to whether there is the capacitor-type sensor coupling circuit 130 are expressed as Equation 6.

$$\frac{Vout\_signal 2}{Vout\_signal 1} = \frac{\frac{A 1 \cdot A 2 \cdot {A}_{p}}{1 - A 1 \cdot {A}_{p} \cdot {A}_{c}}}{A 2 \cdot A 1 \cdot {A}_{p}} \\ \frac{Vout\_noise 2}{Vout\_noise 1} = \frac{\frac{A 1 \cdot A 2}{1 - A 1 \cdot {A}_{p} \cdot {A}_{c}} \cdot Vn 1 + A 2 \cdot Vn 2}{A 2 \cdot A 1 \cdot Vn 1 + A 2 \cdot Vn 2} \qquad [ Equation 6 ]$$

where the constants A1, A2, Aₚ, and A_{c} may be set as follows. For example, A1 is set to 1, A2 is set to 2, Ap is set to 0.8, and Ac is set to 0.9.

Through this, the following Equation 7 is obtained.

$$\begin{matrix}\frac{Vout\_signal 2}{Vout\_signal 1} = \frac{\frac{A 1 \cdot A 2 \cdot {A}_{p}}{1 - A 1 \cdot {A}_{p} \cdot {A}_{c}}}{A 2 \cdot A 1 \cdot {A}_{p}} \\ = 3.5714\end{matrix} \\ \begin{matrix}\frac{Vout\_noise 2}{Vout\_noise 1} = \frac{\frac{A 1 \cdot A 2}{1 - A 1 \cdot {A}_{p} \cdot {A}_{c}} \cdot Vn 1 + A 2 \cdot Vn 2}{A 2 \cdot A 1 \cdot Vn 1 + A 2 \cdot Vn 2} \\ = 2.2857\end{matrix} \qquad [ Equation 7 ]$$

That is, when the signal increases 3.5714 times by the capacitor-type sensor coupling circuit 130, the noise increases 2.2857 times. That is, the SNR of the capacitor-type sensor read-out circuit 100 is improved.

Moreover, since the first amplifier 142 performs a signal amplification operation in the signal processing unit 140, the gain of the second amplifier 143 may be less than that of the first amplifier 142. Through such a configuration, a circuit configuration of the second amplifier 143 may be simplified and also the SNR may be further improved by reducing the noise of the second amplifier 143 (i.e., reduction of Vn2).

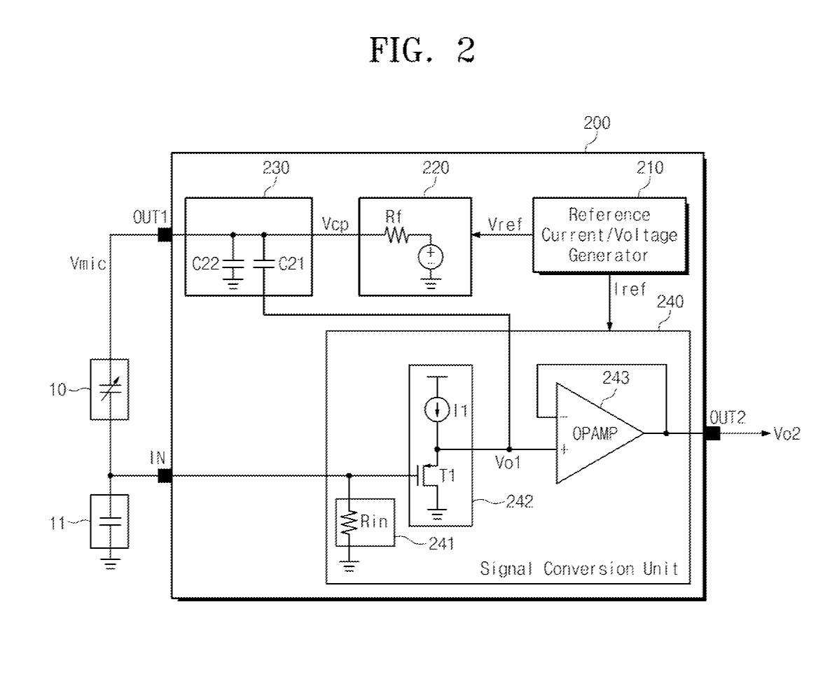

FIG. 2 is a view illustrating a capacitor-type sensor read-out circuit according to another embodiment of the present invention.

Referring to FIG. 2, the capacitor-type sensor read-out circuit 200 includes a reference current/voltage generator 210, a voltage booster 220, a capacitor-type sensor coupling circuit 230, and a signal conversion unit 240.

Except for description of the signal conversion unit 240, description of the read-out circuit 200 refers to that of the read-out circuit 100 of FIG. 1.

The signal conversion unit 240 includes a high impedance circuit 241, a source follower 242, and an operation amplifier 243.

The high impedance circuit 241 has an impedance value Rin. One end of the high impedance circuit 241 is connected to an input terminal IN, and the other end is connected to a ground terminal Through this, the high impedance circuit 241 converts a current signal inputted through a sensor 10 into a voltage signal. The high impedance circuit 241 outputs the converted voltage signal, i.e., a sensor signal, to the source follower 242.

The source follower 242 has a function of outputting input signal with a gain of 1. Here, the source follower 242 includes a current source I1 and a transistor T1.

Through a contract point between a source of the first transistor T and a current source I1, a sensor signal Vo1 is outputted to the operation amplifier 243 and a second capacitor C2 of the capacitor-type sensor coupling circuit 230.

The operation amplifier 243 has a function of controlling a gain of an inputted sensor signal Vo1. Accordingly, the operation amplifier 243 may operate as an output buffer. A plus input terminal − of the operation amplifier 243 is connected to an output terminal of the operation amplifier 243, and receives a sensor signal Vo2 as a feedback. A minus terminal + of the operation amplifier 243 receives the output of the source follower 242.

Here, each of the source follower 242 and the operation amplifier 243 outputs an inputted sensor signal.

Especially, the capacitor-type signal coupling circuit 230 mixes Vo1 outputted from the source follower 242 with a bias voltage outputted through the voltage booster 220 and outputs it to the sensor 10.

The capacitor-type signal coupling circuit 230 includes a third capacitor C21 mixing an AC sensor signal with a bias voltage and a fourth capacitor C22 controlling a gain of a bias signal mixed with a sensor signal.

As shown in FIG. 2, since the capacitor-type sensor read-out circuit 200 has a structure in which a sensor signal is fed back through the capacitor-type sensor coupling circuit 230, a noise ratio of the operation amplifier 243 is reduced.

Due to this, the SNR of the sensor signal Vo2 outputted from the capacitor-type sensor read-out circuit 200 may be improved.

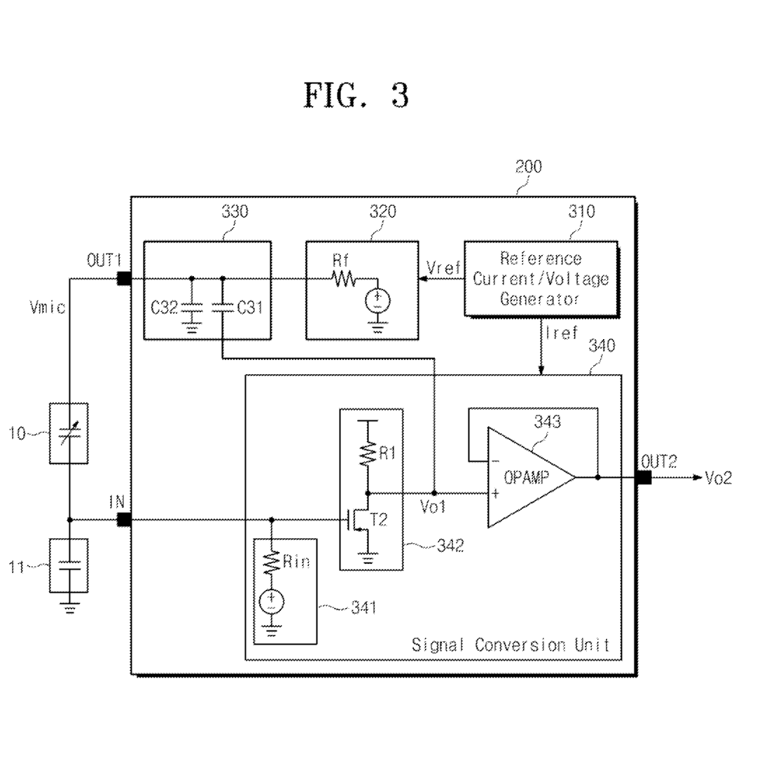

FIG. 3 is a view illustrating a capacitor-type sensor read-out circuit according to another embodiment of the present invention.

Referring to FIG. 3, the capacitor-type sensor read-out circuit 300 includes a reference current/voltage generator 310, a voltage booster 320, a capacitor-type sensor coupling circuit 330, and a signal conversion unit 340. Except for description of the signal conversion unit 340, description of the read-out circuit 300 refers to that of the read-out circuit 100 of FIG. 1.

The signal conversion unit 340 includes a high impedance circuit 341, a common source amplifier 342, and an operation amplifier 343.

The high impedance circuit 341 has an impedance value Rin. One end of the high impedance circuit 341 is connected to an input terminal IN, and the other end is connected to a ground terminal Through this, the high impedance circuit 341 converts a current signal inputted through a sensor 10 into a voltage signal. The high impedance circuit 341 outputs the converted voltage signal, i.e., a sensor signal, to the common source amplifier 342.

Moreover, the high impedance circuit 341 may further include a voltage source for providing a voltage for an operation of a transistor in the common source amplifier 342.

The common source amplifier 342 has a function of controlling a gain of an inputted sensor signal. Here, the common source amplifier 342 includes a resistor 342 and a second transistor T2.

One end of the fourth resistor R1 receives a power voltage and the other end is connected to a drain of the second transistor T2.

A gate of the second transistor T2 receives a voltage signal converted by the high impedance circuit 341. A drain of the second transistor T2 is connected to a ground terminal, and a source of the second transistor T2 is connected to a current source 12.

The common source amplifier outputs to the operation amplifier 343 and a capacitor C31 of the capacitor-type sensor coupling circuit 330.

The operation amplifier 343 has a function of controlling a gain of an inputted sensor signal Vo1. Accordingly, the operation amplifier 343 may operate as an output buffer. A plus input terminal − of the operation amplifier 343 is connected to an output terminal of the operation amplifier 343, and receives a sensor signal Vo2 as a feedback. A minus terminal + of the operation amplifier 343 receives the output of the common source amplifier 342.

Here, each of the source follower 342 and the operation amplifier 343 controls and outputs an inputted sensor signal according to each gain set therein.

Especially, the capacitor-type signal coupling circuit 330 mixes the output signal of the common source amplifier 342 with a bias voltage outputted through the voltage booster 320 and outputs it to the sensor 10.

The capacitor-type signal coupling circuit 330 includes a fifth capacitor C51 mixing an AC sensor signal with a bias voltage and a sixth capacitor C32 controlling a gain of a bias signal mixed with a sensor signal.

As shown in FIG. 3, since the capacitor-type sensor read-out circuit 300 has a structure in which a sensor signal is fed back through the capacitor-type sensor coupling circuit 330, a noise ratio of the operation amplifier 343 is reduced. Due to this, the SNR of the sensor signal Vo2 outputted from the capacitor-type sensor read-out circuit 200 may be improved.

Furthermore, the common source amplifier 342 compensates for a loop gain loss by the parasitic capacitor Cp of the sensor parasite capacitor 11, so that signal amplification performance may be improved.

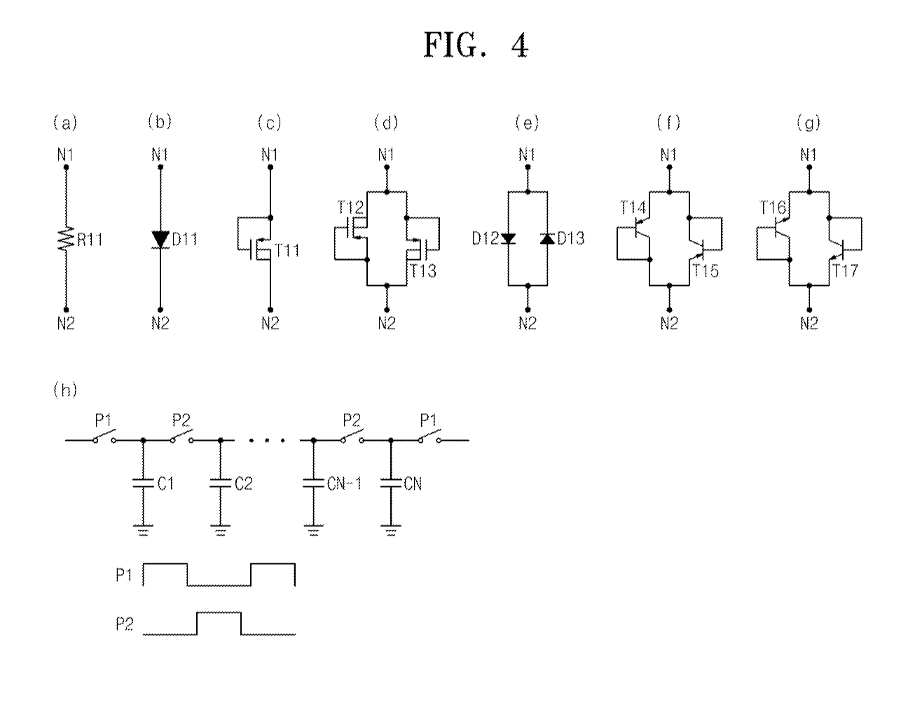

FIG. 4 is a view illustrating a resistance device in a voltage booster of a capacitor-type sensor read-out circuit according to various embodiments of the present invention.

Referring to FIG. 4, the resistance device Rf included in each of the voltage boosters 120, 220, and 320 shown in FIGS. 1 and 3 may be implemented in various forms below.

In FIG. 4(A), the resistance device Rf may be implemented as a typical resistance device R11 between a first node N1 and a second node N2.

In FIG. 4(B), the resistance device Rf may be implemented as a first diode D11 between a first node N1 and a second node N2. The anode + of the first diode D1 is connected to the first node N1 and the cathode − thereof is connected to the second node N2.

In FIG. 4(C), the resistance device Rf may be implemented as a metal-oxide-semiconductor field-effect transistor (MOSFET) T11 between a first node N1 and a second node N2. The source of the MOSFET T11 is connected to the first node N1 and the drain thereof is connected to the second node N2.

In FIG. 4(D), the resistance device Rf may be implemented as two MOSFETs T12 and T13 cross-connected in parallel between a first node N1 and a second node N2. The drain of the second MOSFET T12 is connected to the first node N1 and the source thereof is connected to the second node N2. Additionally, the source of the third MOSFET T13 is connected to the first node N1 and the drain thereof is connected to the second node N2.

In FIG. 4(E), the resistance device Rf may be implemented as two diodes D12 and D13 cross-connected in parallel between a first node N1 and a second node N2. The anode + of the second diode D12 is connected to the first node N1 and the cathode − thereof is connected to the second node N2. The anode + of the third diode D13 is connected to the second node N2 and the cathode − thereof is connected to the first node N1.

In FIG. 4(F), the resistance device Rf may be implemented as two transistors T14 and T15 cross-connected in parallel between a first node N1 and a second node N2. Here, the gate of the third transistor T14 and the drain of the fourth transistor T15 are connected and grounded, so that the third and fourth transistors T14 and T15 are diode-connected for a diode function. The source of the third transistor T14 is connected to the first node N1 and the drain thereof is connected to the second node N2. The source of the fourth transistor T15 is connected to the second node N2 and the drain thereof is connected to the first node N1. For example, the third transistor T14 and the fourth transistor T15 are PMOS transistors.

In FIG. 4(G), the resistance device Rf may be implemented as two transistors T16 and T17 cross-connected in parallel between a first node N1 and a second node N2. Here, the gate of the fifth transistor T16 and the drain of the sixth transistor T17 are connected and grounded, so that the fifth and sixth transistors T16 and T17 are diode-connected for a diode function. The source of the fifth transistor T16 is connected to the first node N1 and the drain thereof is connected to the second node N2. The source of the sixth transistor T17 is connected to the second node N2 and the drain thereof is connected to the first node N1. For example, the fifth transistor T16 and the sixth transistor T17 are NMOS transistors.

Here, each device in FIGS. 4(D) to 4(G) is connected in the form if back-to-back on the basis of the two nodes N1 and N2.

In FIG. 4(H), the resistance device Rf may be implemented as switched-capacitor circuit. Here, switched-capacitor circuit may be included a plurality of two type of switches (P1, P2) and a plurality of capacitors (C1, C2, . . . , CN). The capacitors (C1, C2, . . . , CN) is connected each of contact points between a first switches (P1) and second switches (P2), and each of ground terminals. Here the first switches (P1) and the second switches (P2) are not on simultaneously. In other words, when an on-signal is input into the first switches (P1), an off signal can be input into the second switches (P2), and when an off signal is input into the first switches (P1), an on signal can be input into the second switches (P2). As such, the switched capacitor circuit may be operated as resistor.

In such a manner, the resistance device Rf in each of the voltage boosters 120, 220, and 230 is exemplarily described with reference to FIGS. 4(A) to 4(H) and may be implemented in various forms other than the above forms.

As a result, a capacitor-type sensor read-out circuit according to an embodiment of the present invention uses a structure of a capacitor-type signal coupling circuit that mixes an AC sensor signal outputted from an amplifier, a common source follower, or a common source amplifier, each processing a sensor signal, with a bias voltage provided to the sensor 10. Through this, the SNR of the capacitor-type sensor read-out circuit may improve an SNR. Through this, the capacitor-type sensor read-out circuit may improve the amplification performance of a sensor signal.

Furthermore, the capacitor-type sensor read-out circuit may be manufactured with a small size due to a simple configuration, and may be driven with small power consumption through a passive device.

According to embodiments of the present invention, a capacitor-type sensor read-out circuit applies a signal of a sensor to a bias voltage applied to the sensor, such that a signal to noise ratio of a signal inputted from the sensor may be improved. That is, the capacitor-type sensor read-out circuit may improve the signal amplification performance of a signal inputted from the sensor. Moreover, the capacitor-type sensor read-out circuit has a structure in which a sensor signal is fed back to a bias signal provided to the sensor, so that it may have a small size and consumes less power.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A capacitor-type sensor read-out circuit comprising:
a signal conversion unit outputting a sensor signal inputted from a sensor;
a voltage booster generating a bias voltage; and
a capacitor-type signal coupling circuit receiving the sensor signal as a feedback, mixing the received sensor signal with the bias voltage, and outputting the mixed signal.

2. The capacitor-type sensor read-out circuit of claim 1, wherein the sensor signal mixed with the bias voltage is an alternating current (AC) signal.

3. The capacitor-type sensor read-out circuit of claim 1, wherein the signal conversion unit comprises:
a high impedance circuit converting the sensor signal into a voltage signal;
a first amplifier outputting the sensor signal converted into the voltage signal; and
a second amplifier outputting the sensor signal outputted from the first amplifier.

4. The capacitor-type sensor read-out circuit of claim 3, wherein the capacitor-type signal coupling circuit comprises a first capacitor feeding back the sensor signal outputted from the first amplifier and mixing the sensor signal with the bias voltage.

5. The capacitor-type sensor read-out circuit of claim 4, wherein the capacitor-type signal coupling circuit comprises a second capacitor adjusting and outputting a gain of the bias voltage mixed with the sensor signal.

6. The capacitor-type sensor read-out circuit of claim 1, wherein the signal conversion unit comprises:
a high impedance circuit converting the sensor signal into a voltage signal;
a source follower outputting the sensor signal converted into the voltage signal; and
an operation amplifier outputting the sensor signal outputted from the source follower.

7. The capacitor-type sensor read-out circuit of claim 6, wherein the capacitor-type signal coupling circuit comprises a first capacitor feeding back the sensor signal outputted from the source follower and mixing the sensor signal with the bias voltage.

8. The capacitor-type sensor read-out circuit of claim 7, wherein the capacitor-type signal coupling circuit comprises a second capacitor adjusting and outputting a gain of the bias voltage mixed with the sensor signal.

9. The capacitor-type sensor read-out circuit of claim 1, wherein the signal conversion unit comprises:
a high impedance circuit converting the sensor signal into a voltage signal;
a common source amplifier outputting the sensor signal converted into the voltage signal; and
an operation amplifier outputting the sensor signal outputted from the common source amplifier.

10. The capacitor-type sensor read-out circuit of claim 9, wherein the capacitor-type signal coupling circuit comprises a first capacitor feeding back the sensor signal outputted from the common source amplifier and mixing the sensor signal with the bias voltage.

11. The capacitor-type sensor read-out circuit of claim 10, wherein the capacitor-type signal coupling circuit further comprises a second capacitor adjusting and outputting a gain of the bias voltage mixed with the sensor signal.

12. The capacitor-type sensor read-out circuit of claim 1, wherein the voltage booster comprises:
a voltage source generating a boosting voltage; and
a resistor generating the bias voltage by filtering the boosting voltage.

13. The capacitor-type sensor read-out circuit of claim 12, wherein the resistor comprises at least one of diodes, metal-oxide-semiconductor field-effect transistors (MOSFETs), MOSFETs having a back-to-back structure, diodes having a back-to-back structure, diode-connected P-type metal-oxide-semiconductor (PMOS) transistors having a back-to-back structure, diode-connected N-type metal-oxide-semiconductor (NMOS) transistors having a back-to-back structure, and a switched-capacitor circuit comprising capacitors connect to each of contact points between the alternatively operating switches and each of ground terminals.

14. A capacitor-type sensor read-out circuit comprising:
a high impedance circuit converting a sensor signal inputted from a sensor into a voltage signal;
a first amplifier outputting the sensor signal converted into the voltage signal;
a second amplifier outputting the sensor signal outputted from the first amplifier;
a voltage booster generating a bias voltage; and
a capacitor-type signal coupling circuit receiving the sensor signal outputted from the first amplifier as a feedback, mixing the sensor signal with the bias voltage, and outputting the mixed signal,
wherein the capacitor-type signal coupling circuit comprises:
a first capacitor feeding back the sensor signal outputted from the first amplifier and mixing the sensor signal with the bias voltage; and
a second capacitor adjusting and outputting a gain of the bias voltage mixed with the sensor signal.

15. The capacitor-type sensor read-out circuit of claim 14, wherein the sensor signal mixed with the bias voltage is an AC signal.

16. The capacitor-type sensor read-out circuit of claim 14, wherein the first amplifier comprises a source follower,
wherein the source follower comprises:
a current source having one end receiving a power voltage; and
a transistor having a gate connected to the high impedance circuit, a drain connected to a ground terminal, and a source connected to the other end of the current source.

17. The capacitor-type sensor read-out circuit of claim 14, wherein the first amplifier comprises a common source amplifier,
wherein the common source amplifier comprises:
a resistor having one end receiving a power voltage; and
a transistor having a gate connected to the high impedance circuit, a drain connected to a ground terminal, and a source connected to the other end of the resistor.
